(19) United States
(12) Patent Application Publication
(10) Pub. No.: US 2017/0013475 A1
(43) Pub. Date: Jan. 12, 2017

(54) Performance Improvement in Wireless Communications Networks

(71) Applicant: Telefonaktiebolaget L M Ericsson (publ), Stockholm (SE)

(72) Inventors: Panagiota Lioliou, Sundbyberg (SE); Harald Kallin, Sollentuna (SE); Birgitta Olin, Bromma (SE); Pradeepa Ramachandra, Linköping (SE); Kristina Zetterberg, Linköping (SE)

(21) Appl. No.: 14/759,974

(22) PCT Filed: Jul. 8, 2015
(86) PCT No.: PCT/EP2015/065534

§ 371 Date: Jul. 9, 2015

(51) Int. Cl. H04W 24/02; H04W 36/00; H04W 24/10

(52) U.S. Cl. CPC H04W 24/02; H04W 24/10; H04W 36/0083

(57) ABSTRACT

There is provided mechanisms for improving performance in a wireless communications network. A method is performed by a network node. The method comprises acquiring an identification of a set of cells for which adjustment is needed. The method comprises identifying a reason for the adjustment and improvement possibilities of the set of cells using at least one indicator. The reason and the improvement possibilities define a combination of which parameters and network nodes that could be adjusted. The method comprises determining an improvement action for the set of cells by jointly optimizing the combination of parameters and network nodes based on the reason and the improvement possibilities.

### TECHNICAL FIELD

Embodiments presented herein relate to wireless communications network, and particularly to a method, a network node, a computer program, and a computer program product for improving performance in a wireless communications network.

### BACKGROUND

In communications networks, there may be a challenge to obtain good performance and capacity for a given communications protocol, its parameters and the physical environment in which the communications network is deployed.

For example, one way to increase the capacity and/or coverage of a wireless network communications is to deploy reconfigurable antenna systems. A Reconfigurable Antenna System (RAS) may change the radiation characteristics of the antenna pattern of a radio access network node to adapt the shape of the cell in which the radio access network node provides network coverage. This is denoted as cell shaping. Some examples of antenna parameters that can be tuned are the antenna beam pointing direction, both in elevation (tilt) and azimuth domain, and the antenna beam width, both in elevation and azimuth domain. One advantage of cell shaping is that it does not require any special support from wireless devices, such as user equipment, served in the cell. Thus, cell shaping can be applied to a network with legacy UEs in both Long-Term Evolution (LTE) systems and Universal Mobile Telecommunications System (UMTS). Additional benefits may include extended coverage due to better antenna gain, higher capacity by avoiding interference, smooth introduction of new cells into existing networks, etc.

Automated solutions provided by Self-Organizing Networks (SON) may be used for realizing the cell shaping functionality. SON can enable self-configuration of antenna parameters at deployment, self-optimization when parameters are changing and self-healing for reducing the impact of cell or site (i.e., radio access network node) outages by redirecting resources in surrounding cells. A SON functionality aiming at reconfiguring antenna parameters for load balancing, coverage and capacity optimization, and self-healing purposes have been proposed.

In existing SON mechanisms, the antenna parameter tuning is performed either separately for each cell, i.e., by tuning only one cell at the time, or for several cells simultaneously. In the latter case, the simultaneous tuning of multiple cells may be performed either independently without being aware of the changes in other cells, or jointly by treating the cells in the same way (as if they were only one cell) without considering their individual properties. For example, a congested cell and one or several neighboring cells may be selected for joint tilt tuning for load balancing purposes. The congested cell and the neighboring cells may then iteratively change the antenna tilts; a down-tilt adjustment in the congested cell is followed by an up-tilt adjustment in the neighboring cells. In the case of multiple neighbors selected as candidates for off-loading, the up-tilt adjustment may be done either individually for each cell, or simultaneously by up-tilting all neighboring cells at the same time.

At least two potential issues could be foreseen in SON mechanisms. These will be summarized next. Firstly, the chosen antenna dimension (multi cell joint optimization of a parameter and/or multi antenna parameter joint optimization in the same cell) will be fixed for different iterations of a SON function. Secondly, within the chosen antenna dimension, the directions of change in the antenna radiation patterns are not correlated with the reason for the selection of the antenna dimension.

Tuning the antenna parameters only for one cell at the time or for several cells either independently or by handling the cells in exactly the same way limits the available search space and consequently the antenna parameter combinations evaluated by the SON functionality. For example, the first cell that is being tuned might have ended up with different antenna settings if a neighboring cell had been tuned first, or if it has been tuned jointly with another cell, and vice versa. This means that some beneficial combinations of antenna settings in the selected cell/s may never be evaluated, resulting in a suboptimal solution and reduced optimization gains. A disadvantage with independently tuning each cell without taking into account the reason for poor performance and the improvement possibilities in neighboring cells is that it may disrupt network operation by evaluating poor antenna parameter settings that can deteriorate network performance. Another disadvantage is that the iteration time for finding the best parameter settings may become significantly long, since sufficient network statistics need to be collected depending on the time needed to capture the average characteristics of the cells under optimization.

Hence, there is still a need for improved mechanisms for improving performance in a wireless communications network.

### SUMMARY

An object of embodiments herein is to provide efficient mechanisms for improving performance in a wireless communications network.

According to a first aspect there is presented a method for improving performance in a wireless communications network. The method is performed by a network node. The method comprises acquiring an identification of a set of cells for which adjustment is needed. The method comprises identifying a reason for said adjustment and improvement possibilities of said set of cells using at least one indicator, wherein said reason and said improvement possibilities define a combination of which parameters and network nodes that could be adjusted. The method comprises determining an improvement action for said set of cells by jointly optimizing said combination of parameters and network nodes based on said reason and said improvement possibilities.

Advantageously this provides an efficient mechanism for improving performance in a wireless communications network.

Advantageously this allows the full dynamics of antenna parameter (or parameters) changes in the cell (or cells) under evaluation can be utilized, resulting in less iteration time, faster adaptation to a near optimal value and reduced performance degradations during measurements and evaluations of candidate antenna settings in comparison to known SON mechanisms.

According to a second aspect there is presented a network node for improving performance in a wireless communications network. The network node comprises processing circuitry. The processing circuitry is configured to cause the network node to perform a set of operations. The processing circuitry is configured to cause the network node to acquire an identification of a set of cells for which adjustment is needed. The processing circuitry is configured to cause the network node to identify a reason for said adjustment and improvement possibilities of said set of cells using at least one indicator, wherein said reason and said improvement possibilities define a combination of which parameters and network nodes that could be adjusted. The processing circuitry is configured to cause the network node to determine an improvement action for said set of cells by jointly optimizing said combination of parameters and network nodes based on said reason and said improvement possibilities.

According to a third aspect there is presented a computer program for improving performance in a wireless communications network, the computer program comprising computer program code which, when run on a network node, causes the network node to perform a method according to the first aspect.

According to a fourth aspect there is presented a computer program product comprising a computer program according to the third aspect and a computer readable means on which the computer program is stored.

It is to be noted that any feature of the first, second, third and fourth aspects may be applied to any other aspect, wherever appropriate. Likewise, any advantage of the first aspect may equally apply to the second, third, and/or fourth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1a, 1b, and 1c are schematic diagrams illustrating a communication network according to embodiments;

FIG. 2a is a schematic diagram showing functional units of a network node according to an embodiment;

FIG. 2b is a schematic diagram showing functional modules of a network node according to an embodiment;

FIG. 3 shows one example of a computer program product comprising computer readable means according to an embodiment;

FIGS. 4, 5, and 6 are flowcharts of methods according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

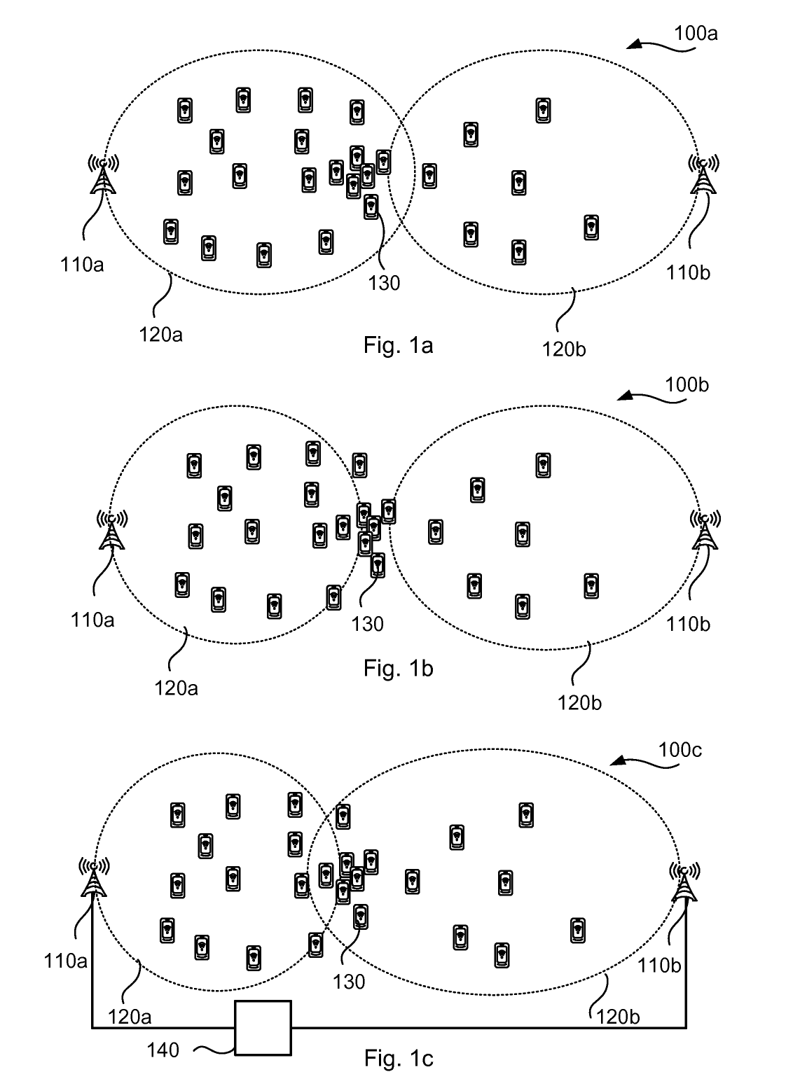

FIG. 1 is a schematic diagram illustrating a communications network 100a where embodiments presented herein can be applied. The communications network 100 comprises network nodes 110a, 110b, each providing network coverage in a respective cell 120a, 120b. A wireless device 130 inside such a cell may thus access network services as provided by the network nodes 110a, 110b. In turn, each network nodes 110a, 110b may be operatively connected to a core network which in turn is operatively connected to a service network. A wireless device may thereby exchange data with the service network via a network node 110a, 110b. Each network node 110a, 110b may be provided as a radio access network node, such as a radio base station; base transceiver station; node B; evolved node B; access point, or the like. Each wireless device 130 may be a portable wireless device, such as a mobile station, mobile phone, handset, wireless local loop phone, user equipment (UE), smartphone, laptop computer, tablet computer, sensor device, modem, or the like.

Consider the example scenario of FIG. 1a, where a first cell, hereinafter defined by cell 120a is assumed to be underperforming. It is by the network node 110a, 110b, 140 determined that the performance problem is due to a large number of wireless devices 130 being served in cell 120a, compared to the number of wireless devices being served in cells surrounding cell 120a, one of which is referred to as cell 120b. Hence, a possible mechanism for improving network performance could be to reduce the coverage size of cell 120a. In such a situation, one way of trying to remedy the underperforming cell would thus be to decrease the coverage area of cell 120a by changing parameters of the network node 110a resulting in an increased antenna down tilt, a more narrow antenna beam being used, and/or the antenna beam being turned in the horizontal plane.

But performing an improvement action for cell 120a in isolation may result in worse performance for wireless devices 130 that will end up outside the cells 120a, 120b, as illustrated in the communications network 100b of FIG. 1b. In FIG. 1b, due to the changes in the radiation pattern of cell 120a compared to in FIG. 1a, the coverage area of cell 120a has decreased, thereby excluding some of the previously served wireless devices 130 from network service. Thus, cell 120a has introduced a coverage hole. Coverage holes are generally unacceptable for operators as some wireless devices 130 will end up having network service with degraded quality or no network service at all.

The herein disclosed embodiments enables optimization parameters such as antenna radiation patterns in multi-dimensional space using joint optimization in a cluster wherein the multi-dimension space could refer to a single antenna parameter tuning in two or more cells jointly or tuning of two or more antenna parameters in the same cell, or both, without exploring all possible antenna radiation pattern combinations of the multi-dimension space, thereby improving the performance in the cluster and avoiding possible performance degradations resulting from selection of improper antenna radiation patterns in the multi-dimensional space. How the embodiments disclosed herein thereby may handle issues as identified in FIG. 1b will be disclosed below.

The embodiments disclosed herein particularly relate to improving performance in a wireless communications network. In order to obtain such improvement there is provided a network node, a method performed by the network node, a computer program comprising code, for example in the form of a computer program product, that when run on the network node, causes the network node to perform the method.

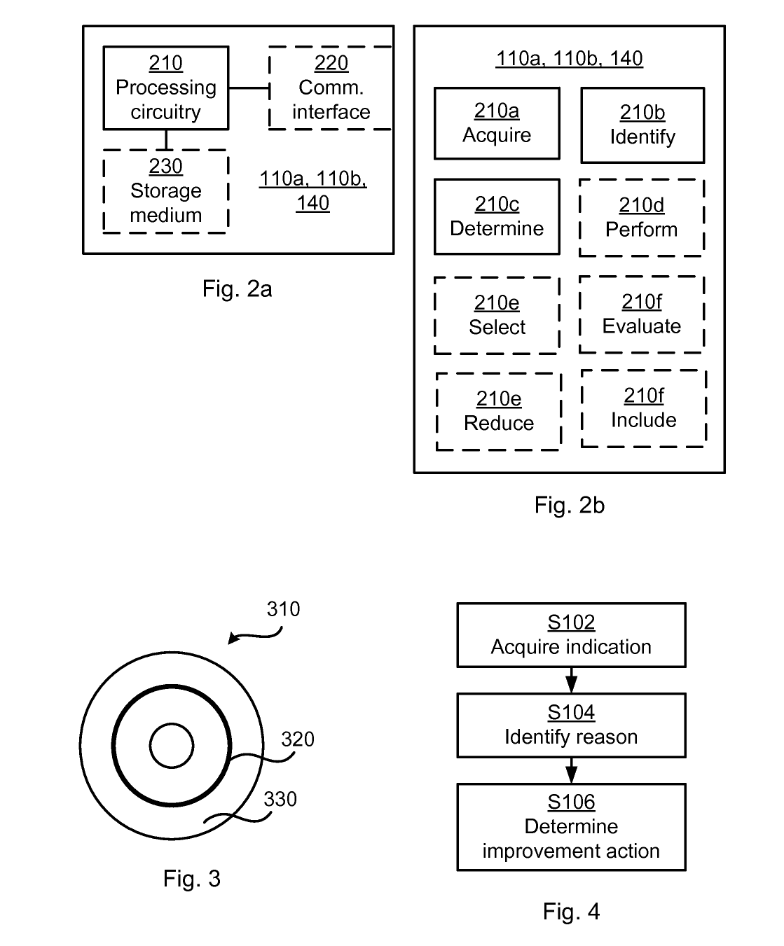

FIG. 2a schematically illustrates, in terms of a number of functional units, the components of a network node 110a, 110b, 140 according to an embodiment. Processing circuitry 210 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 310 (as in FIG. 3), e.g. in the form of a storage medium 230.

Particularly, the processing circuitry 210 is configured to cause the network node 110a, 110b, 140 to perform a set of operations, or steps, S102-S108, S201-S207. These operations, or steps, S102-S108, S201-S207 will be disclosed below. For example, the storage medium 230 may store the set of operations, and the processing circuitry 210 may be configured to retrieve the set of operations from the storage medium 230 to cause the network node 110a, 110b, 140 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 110a, 110b, 140 may further comprise a communications interface 220 for communications with at least one other network node 110a, 110b, 140 and for providing network services to wireless devices 130 within a cell 120a, 120b. As such the communications interface 220 may comprise one or more transmitters and receivers, comprising analogue and digital components. The processing circuitry 210 controls the general operation of the network node 110a, 110b, 140 e.g. by sending data and control signals to the communications interface 220 and the storage medium 230, by receiving data and reports from the communications interface 220, and by retrieving data and instructions from the storage medium 230. Other components, as well as the related functionality, of the network node 110a, 110b, 140 are omitted in order not to obscure the concepts presented herein.

FIG. 2b schematically illustrates, in terms of a number of functional modules, the components of a network node 110a, 110b, 140 according to an embodiment. The network node 110a, 110b, 140 of FIG. 2b comprises a number of functional modules; an acquire module 210a configured to perform below steps S102, S102a, S102a′, S106a, an identify module 210b configured to perform below step S102d, S104, and a determine module 210c configured to perform below step S106. The network node 110a, 110b, 140 of FIG. 2b may further comprises a number of optional functional modules, such as any of a perform module 210d configured to perform below step S108, a select module 210e configured to perform below steps S102e, S102f, S102h, an evaluate module 210f configured to perform below step S102g, a reduce module 210e configured to perform below steps S102b, S102b′, and an include module 210f configured to perform below steps S102c, S102c′. The functionality of each functional module 210a-210f will be further disclosed below in the context of which the functional modules 210a-210f may be used. In general terms, each functional module 210a-210f may be implemented in hardware or in software. Preferably, one or more or all functional 210a-210f may be implemented by the processing circuitry 210, possibly in cooperation with functional units 220 and/or 230. The processing circuitry 210 may thus be arranged to from the storage medium 23 fetch instructions as provided by a functional module 210a-210f and to execute these instructions, thereby performing any steps as will be disclosed hereinafter.

The network node 110a, 110b, 140 may be provided as a standalone device or as a part of a further device. For example, the network node 110a, 110b, 140 may be provided in a radio access network node 110a, 110b, and/or in a central management node 140. Alternatively, functionality of the network node 110a, 110b, 140 may be distributed between at least two devices, or nodes. These at least two nodes, or devices, may either be part of the same network part (such as a radio access network or a core network) or may be spread between at least two such network parts. In general terms, instructions that are required to be performed in real time may be performed in a device, or node, operatively closer to the cells 120a, 120b than instructions that are not required to be performed in real time. In this respect, at least part of the network node 110a, 110b, 140 may reside in the radio access network, such as in a radio access network node 110a, 110b, for cases when embodiments as disclosed herein are performed in real time.

Thus, a first portion of the instructions performed by the network node 110a, 110b, 140 may be executed in a first device, and a second portion of the of the instructions performed by the network node 110a, 110b, 140 may be executed in a second device; the herein disclosed embodiments are not limited to any particular number of devices on which the instructions performed by the network node 110a, 110b, 140 may be executed. Hence, the methods according to the herein disclosed embodiments are suitable to be performed by a network node 110a, 110b, 140 residing in a cloud computational environment. Therefore, although a single instance of a processing circuitry 210 is illustrated in FIG. 2a the processing circuitry 210 may be distributed among a plurality of devices, or node. The same applies to the functional modules 210a-210f of FIG. 2b and the computer program 320 of FIG. 3 (see below).

FIG. 3 shows one example of a computer program product 310 comprising computer readable means 330. On this computer readable means 330, a computer program 320 can be stored, which computer program 320 can cause the processing circuitry 210 and thereto operatively coupled entities and devices, such as the communications interface 220 and the storage medium 230, to execute methods according to embodiments described herein. The computer program 320 and/or computer program product 310 may thus provide means for performing any steps as herein disclosed.

In the example of FIG. 30, the computer program product 310 is illustrated as an optical disc, such as a CD (compact disc) or a DVD (digital versatile disc) or a Blu-Ray disc. The computer program product 310 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 320 is here schematically shown as a track on the depicted optical disk, the computer program 320 can be stored in any way which is suitable for the computer program product 310.

FIGS. 4, 5, and 6 are flow charts illustrating embodiments of methods for improving performance in a wireless communications network. The methods are performed by the network node 110a, 110b, 140. The methods are advantageously provided as computer programs 320.

Reference is now made to FIG. 4 illustrating a method for improving performance in a wireless communications network as performed by a network node 110a, 110b, 140 according to an embodiment.

The network node 110a, 110b, 140 is configured to, in a step S102, acquire an identification of a set of cells 120a, 120b for which adjustment is needed. Examples of how the identification may be acquired will be provided below.

At least some of the herein disclosed embodiments are based on identifying the optimal antenna radiation pattern changing dimension or dimensions based on an analysis of the problem area around the problematic cell or cells and mapping the reason for selecting the antenna parameter pattern changing dimension or dimensions to the direction of changing the antenna parameters. The network node 110a, 110b, 140 is therefore configured to, in a step S104, identify a reason for the adjustment and improvement possibilities of the set of cells 120a, 120b using at least one indicator. Examples of indicators and how they may be used to identify the adjustment and improvement possibilities will be provided below. The reason and the improvement possibilities define a combination of which parameters and network nodes 110a, 110b that could be adjusted.

The network node 110a, 110b, 140 is then configured to, in a step S106, determine an improvement action for the set of cells 120a, 120b. Different examples of improvement actions and how they may be determined will be provided below. The improvement action is by the network node 110a, 110b, 140 determined by jointly optimizing the combination of parameters and network nodes based on the reason and the improvement possibilities. The method thereby optimizes antenna radiation patterns in multi-dimensional space joint optimization in a cluster, where, as will be further disclosed below, the multi-dimension space could refer to single antenna parameter tuning in two or more cells 120a, 120b jointly or two or more antenna parameter tuning in the same cell, or both, without exploring all the possible antenna radiation pattern combinations of the multi-dimension space, thereby possibly improving the performance in the cluster and avoiding possible performance degradations resulting from the improper selection of antenna radiation patterns in the multi-dimensional space.

Embodiments relating to further details of improving performance in a wireless communications network will now be disclosed.

In one embodiment, at least two cells 120a, 120b are selected to be tuned and the network node 110a, 110b, 140 then optimizes the antenna parameters for these cells 120a, 120b by evaluating different combination of antenna parameter settings simultaneously. The degrees of freedom in the antenna settings will then be equal to the number of parameters tuned times the number of cells 120a, 120b that are being tuned. In another embodiment, two or more antenna parameters are selected for joint optimization in the same cell 120a. Hence, the combination of parameters and nodes may be defined by one antenna parameter and at least two network nodes, or at least two antenna parameters and one network node. In yet another embodiment, two or more antenna parameters are selected for joint optimization in two or more cells 120a, 120b.

There may be different ways to identify the set of cells for which adjustment is needed For example, the indication may be based on a performance observation of the set of cells 120a, 120b. The performance observation may indicate worse performance for the set of cells 120a, 120b than for other cells in the wireless communications network. Additionally, if a cell 120a is exhibiting a high load, then improvement actions that can be assumed to further increase the load of the cell 120a should be avoided so as to avoid cell congestion. The use of performance observations may thereby avoid the improvement action to involve such undesired options, thereby reducing the number of options considered when determining the improvement action.

There may be different ways for the performance to be indicated. In general terms, the set of cells 120a, 120b to be tuned may be selected based on one or more Key Performance Indicators (KPIs) such as cell performance, cell load, cell signal strength, cell throughput, cell interference, etc. Hence, according to an embodiment the at least one indicator is a key performance indicator.

According to another embodiment the at least one indicator is a deployment indicator. The deployment indicator may relate to the infrastructure or environmental information for location where the network nodes 110a, 110b of the set of cells 110a, 110b are placed and where wireless devices 130 intended to be served by the network nodes 110a, 110b are likely to be located. That is the deployment indicator may relate to at least one of infrastructure information and environmental information of a geographical region corresponding to the set of cells 120a, 120b. As an example, the infrastructure information and environmental information may represent information about antenna height (i.e., the heights at which the antennas serving the set of cells 120a, 120b are located) compared to the terrain and/or buildings surrounding the antenna height. For example, if an antenna is placed on the top of a high building (compared to its surrounding buildings) then the improvement action should not involve an option comprising tilting the antenna in an upwards direction (i.e., a direction above the horizon); likewise, an option comprising tilting an antenna mounted close to the ground and being surrounded by tall structures in a downwards direction (i.e., a direction below the horizon) should be avoided. The use of infrastructure information and environmental information may avoid the improvement action to involve such undesired options, thereby reducing the number of options considered when determining the improvement action.

According to yet another embodiment the at least one indicator is a memory indicator. For example, the memory indicator may relate to any previously performed improvements actions for the set of cells 120a, 120b or any previously performed improvements actions for a cell neighbouring the set of cells 120a, 120b. In this way improvement actions that have led to unsatisfactory network performance in the past can be avoided, assuming that an objective function to be optimized when determining the improvement action has not changed. The memory indication may thus avoid the improvement action to involve such undesired options, thereby reducing the number of options considered when determining the improvement action.

According to yet another embodiment the at least one indicator is a combination of indicators as disclosed in the previous embodiments.

The antenna parameter search space may thereby be refined based on the at least one indicator, i.e., by taking into account the reason for poor performance and the improvement possibilities in the selected set of cells 120a, 120b, to avoid testing combinations of antenna parameter settings that will most likely not yield any gains, or even deteriorate, the network performance.

There may be different examples of improvement possibilities. For example, the improvement possibilities may relate to user off-loading, cell interference reduction, cell coverage improvement, or any combination thereof.

There may be different examples of improvement actions. For example, the improvement action may involve adjustment vertical beam direction, horizontal beam direction, beam width, or any combination thereof.

As noted above the at least one indicator is used to identify the reason for the adjustment and improvement possibilities. This at least one indicator may thus be used to implicitly determine the reason for the adjustment and improvement possibilities of the set of cells 12a, 120b. There may be further ways to determine the reason for the adjustment and improvement possibilities of the set of cells 12a, 120b. For example, the reason may be determined from an observed imbalance between cells in the set of cells 120a, 120b, where the observed imbalance relates to load, interference, coverage, user throughput, or any combination thereof, in the set of cells 120a, 120b.

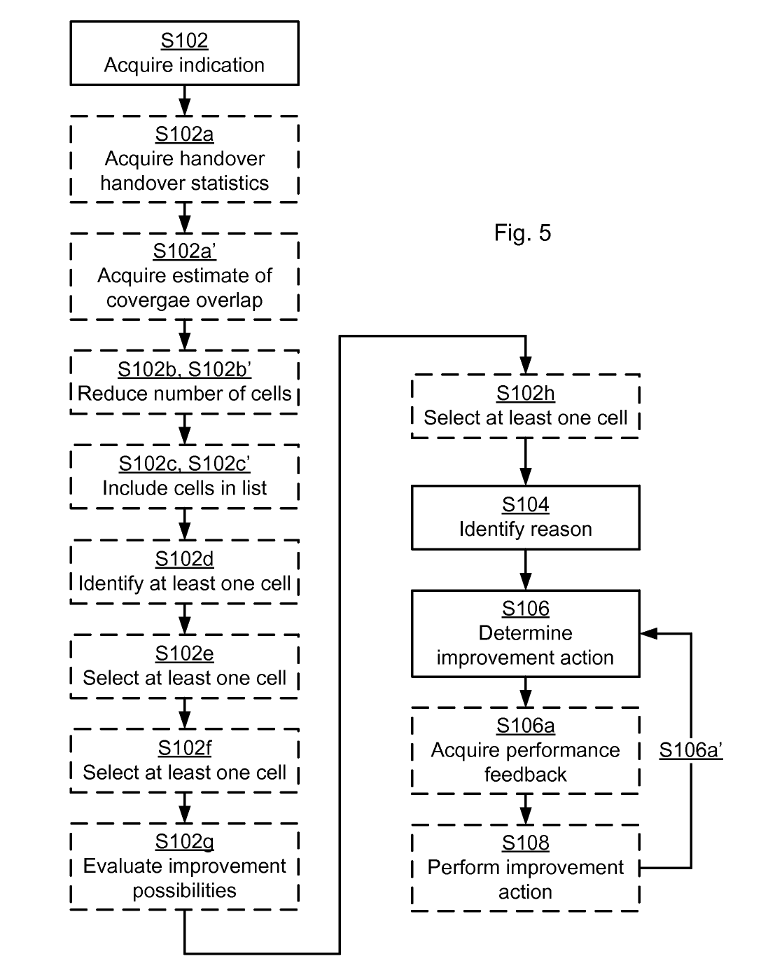

Reference is now made to FIG. 5 illustrating methods for improving performance in a wireless communications network as performed by a network node 110a, 110b, 140 according to further embodiments.

A first group of embodiments relate to how the identification can be acquired in step S102.

In one embodiment the set of cells comprises a single cell 120a, and the identification comprises a list of cells 120b neighbouring the single cell 120a. Here the term neighbouring is to be interpreted as in the vicinity of the single cell 120a, related to the single cell 120a, and/or in radio closeness to the single cell 120a, and hence not necessarily in a cellular technology context where the term neighbouring often means a cell that can be used for handover to from the single cell 120a.

The network node 110a, 110b, 140 may then be configured to, in a step S102a, acquire handover statistics for the single cell 120a with respect to cells 120b in the list of cells. These handover statistics can be used to reduce the number of cells in the list of cells 120b. Hence, the network node 110a, 110b, 140 may be configured to, in a step S102b, reduce the number of cells in the list of cells 120b based on the handover statistics. For example, cells in the list of cells 120b with relative (i.e., compared to other cells in the list of cells 120b) few handovers to and/or from the single cell 120a may be removed. The network node 110a, 110b, 140 may then be configured to, in a step S102c, include the reduced number of cells in the set of cells. This process may thus reduce the search space when determining the improvement action.

Further, the neighbour list may be refined by using overlap information. For example, a relative large overlap zone between two cells 120a, 120b (compared to the overlap zone between two other cells in the wireless communications network) indicates a potential for moving the cell borders between the cells The network node 110a, 110b, 140 may therefore be configured to, in a step S102a′, acquire an estimate of coverage overlap for the single cell 120a with respect to cells in the list of cells 120b. The estimate may be acquired by means of measurements of live traffic from wireless devices 130 in the overlapping cells 120a, 120b, where the coverage overlap may be estimated based on the share of wireless devices 130 having a received signal strength difference between the overlapping cells 120a, 120b being smaller than a threshold; the larger share above the threshold the larger the overlap. Alternatively, the estimate may be acquired by means of simulations of traffic from wireless devices 130 in the overlapping cells 120a, 120b.

The coverage overlap can be used to reduce the number of cells in the list of cells 120b. Hence, the network node 110a, 110b, 140 may be configured to, in a step S102b′, reduce the number of cells in the list of cells 120b based on the coverage overlap. For example, cells in the list of cells 120b with relative (i.e., compared to other cells in the list of cells 120b) relative small coverage overlap with the single cell 120a may be removed. The network node 110a, 110b, 140 may then be configured to, in a step S102c′, include the reduced number of cells in the set of cells. This process may thus reduce the search space when determining the improvement action.

In a yet further embodiment the network node 110a, 110b, 140 is configured to, in a step S102d, identify at least one cell 120a for which adjustment is needed. The at least one cell 120a is part of the set of cells 120a, 120b.

There may be different ways of identifying the at least one cell 120a for which adjustment. The at least one cell 120a may be selected at random or pseudo-randomly, i.e., where the probability of selecting the at least one cell 120a is weighted with some attribute, for example the cell load, interference or other relevant KPIs. Thus, the network node 110a, 110b, 140 may be configured to, in a step S102e, select the at least one cell 120a from the set of cells 120a, 120b based on performance of the cells 120a, 120b in the set of cells 120a, 120b, and/or, in a step S102f, select the at least one cell 120a from the set of cells 120a, 120b in accordance with a probability factor weighted according to the at least one indicator.

Further, the at least once cell 120a may be selected so as to enable evaluation of combinations in a very limited set of improvement possibilities with highest improvement potential. Hence, the network node 110a, 110b, 140 may be configured to, in a step S102g, evaluate the improvement possibilities for each cell 120a in the set of cells 120a, 120b ; and, in a step S102h, select the at least one cell 120a from the set of cells 120a, 120b based on the evaluated improvement possibilities.

Examples of properties according to which the improvement action may be determined have been disclosed above. There may be yet further different ways to determine the improvement action. For example, determining the improvement action may involve the network node 110a, 110b, 140 to, in a step S106a or S106a′, be configured to acquire performance feedback from the set of cells 106a, 106b. According to an embodiment at least one occurrence of the improvement action (see step S108 below) is performed in order for performance feedback (based on performance measurements) to be acquired, as in step S106a′. According to another embodiment the performance feedback is provided as stored performance feedback and hence at least one occurrence of the improvement action need not to be performed in order for performance feedback to be acquired, as in step S106a.

Once the improvement action has been determined it may also be executed. The improvement action may be performed by the network node 110a, 110b, 140. Hence, according to an embodiment the network node 110a, 110b, 140 is configured to, in a step S108, perform the improvement action.

As a result of the improvement action having been performed, individual cell or wireless device performance may decline at the benefit of a common good, affecting a larger group of wireless devices 130; i.e., although an individual cell or wireless device may experience worse performance after the improvement action has been performed in step S108, the performance of the wireless communications network as a whole is improved.

Further, the network node 110a, 110b, 140 may be configured to evaluate the improvement action after it has been performed, for example by acquiring performance feedback, as in step S106a′. Based on this performance feedback another improvement action may be determined and executed, as in step S108. Such another improvement action may revert any previously performed improvement action, for example in case the determined improvement action turned out not to improve (or even degrade) network performance.

As noted above, functionality of the network node 110a, 110b, 140 may be distributed between at least two devices, or nodes. What is denoted as a network node 110a, 110b, 140 may thus relate to a control functionality that may be located centrally (e.g. in an operations, administration, and management (OAM) system) or distributed (e.g. in radio access network nodes) or to a hybrid, shared, responsibility.

In one embodiment all the decisions about cell selection, neighbor selection and antenna parameter change direction selection of the set of cells 120a, 120b is taken centrally via a network node 140 provided in a central OAM system. In another embodiment, only parts of such cell selection, neighbor selection and antenna parameter change direction selection of the set of cells 120a, 120b is taken centrally and the rest of the decisions are taken in localized network nodes 110a, 110b in a distributed way via communications over the X2 interface.

One example of a distributed selection involves the network node 140 in the OAM system to select the set of cells 120a, 120b to optimize and allows antenna parameter optimization to be performed in the selected set of cells 120a, 120b. The remaining operations for improving performance in a wireless communications network are then performed by the network nodes 110a, 110b, via communications over the X2 interface between the network nodes 110a, 110b.

Reference is again made to the above example as illustrated in FIGS. 1a and 1b. The issues noted in this example, such as the possibility of introducing coverage holes, are resolved using the herein disclosed mechanisms for improving performance in a wireless communications network. In one of the embodiments, at least one additional cell 120b is identified to carry out the antenna parameter optimization jointly with cell 120a. The selection of the at least one additional cell 120b is used for determining the type of radiation pattern change in both the problematic cell, i.e., cell 120a, and the additional at least one cell 120b. An example of such a change is illustrated in FIG. 1c. In FIG. 1c, cell 120a and cell 120b are selected for joint antenna parameter optimization and the direction of change of antenna radiation pattern for cell 120a is such that the coverage area of cell 120a is reduced and the direction of change of antenna radiation pattern for cell 120b is such that it provides coverage to the wireless devices 120 that are being offloaded by cell 120a. In this way, the joint antenna radiation pattern optimization of two or more cells 120a, 120b in a pre-identified direction based on the reason for poor performance in cell 120a will help in resolving the problems in the area.

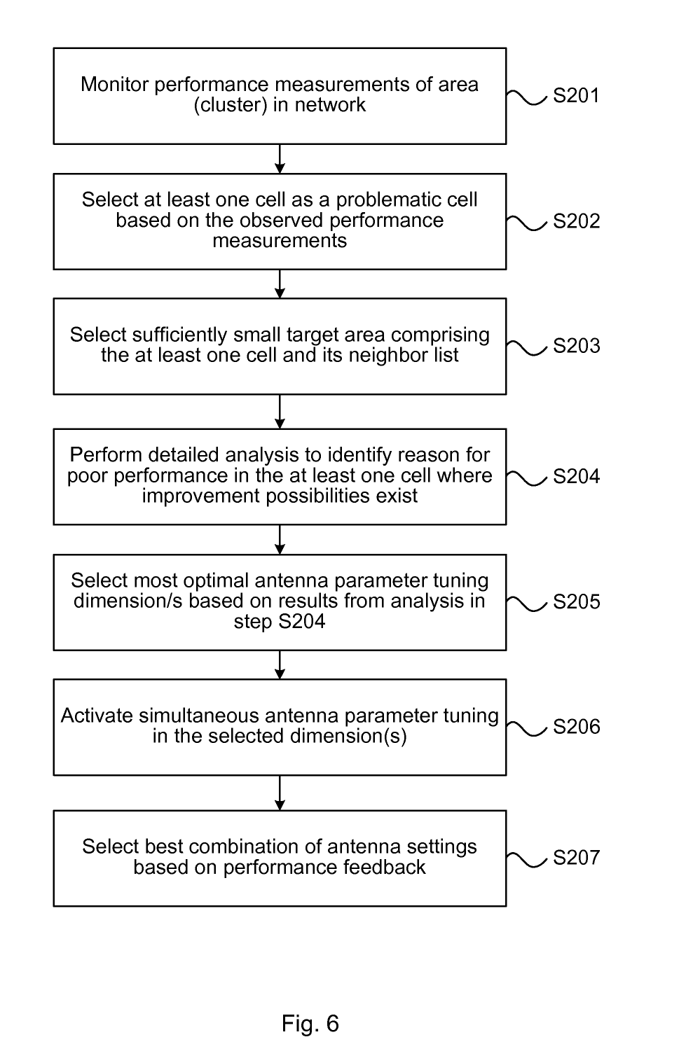

One particular embodiment for improving performance in a wireless communications network 100a, 100b, 100c will now be disclosed with reference to the flowchart of FIG. 6.

S201: The network node 110a, 110b, 140 continuously monitors an area of the communications network based on performance measurements. In more detail, the area may correspond to the whole communications network or a part of the communications network (such as a cluster of cells 120a, 120b) to find problematic areas and improvement possibilities. Monitoring is constantly active and is based on performance measurements, either collected directly from the monitored cells 120a, 120b, or provided by an operations support system (OSS).

S202: Cell 120a is selected as a problematic cell based on the observed performance measurements. One way to implement step S202 is to perform step S102. In more detail, based on the observed performance measurements, the network node 110a, 110b, 140 selects a cell, cell 120a, with poor performance to be optimized. Several problematic cells may exist in non-correlated areas in the whole communications network.

S203: A sufficient small target area is selected that consists of cell 120a and its neighbor list, not limited to an Automatic Neighbour Relation (ANR) list only. One way to implement step S203 is to perform any of steps S102d, S102e, or S102f. In more detail, after identifying Cell 120a, a sufficiently small target area is selected by the network node 110a, 110b, 140. The selected target area typically consists of cell 120a and its neighbor list. The neighbor list may be further refined by using, for example, handover statistics, i.e., handover attempts, handover failures, etc.

S204: A detailed analysis is performed in the selected target area to identify the reason for poor performance (e.g., load, interference, poor signal strength) in cell 120a and where improvement possibilities exist. One way to implement step S204 is to perform step S104. In more detail, the detailed analysis may assess improvement possibilities in the neighboring cells so that an improvement action may be determined. Improvement possibilities may include user off-loading, interference reduction and/or coverage improvement and can be identified by using measurements in the selected target area related to load, interference, signal strength etc. The improvement action will determine what specific improvement is needed and how to apply it. This action may be to jointly reconfigure some antenna parameters in a number of cells 120a, 120b in the target area like tilt, azimuth beam pointing direction, and beam width, both in vertical and azimuth domain.

S205: Based on the results from analysis in step S204, the network node 110a, 110b, 140 selects the most optimal antenna parameter tuning dimension or dimensions wherein the dimension or dimensions refer to multi cell joint antenna parameters and/or single cell multi-(antenna) parameters. One way to implement step S205 is to perform step S106. In more detail, based on the detailed analysis and the improvement action, one or more neighboring cells with the highest improvements possibilities are selected for simultaneous antenna parameter tuning with cell 120a.

S206: Simultaneous antenna parameter tuning in the selected dimension or dimensions is activated by the network node 110a, 110b, 140. The number of evaluated combinations of antenna settings may be reduced based on the reason for poor performance in cell 120a and the improvement possibilities in the selected dimension or dimensions. One way to implement step S206 is to perform any of steps S102a-S102c, S102a′-S102c′, S102g, S102h. In more detail, in this way not every possible combination of antenna settings is evaluated blindly, but instead a limited number of combinations with the highest improvement potential are tried out, resulting is less iteration time and reduced performance degradations.

S207: The network node 110a, 110b, 140 selects the best combination of antenna settings based on performance feedback from the whole communications network or a smaller part of the communications network around the selected target area and performs the improvement action. One way to implement step S207 is to perform any of steps S106a, S106a′, S108.

Assume a first embodiment where the joint optimization is performed for a combination of a single parameter for two or more cells 120a, 120b. Assume a second embodiment where the joint optimization is performed for a combination of two or more parameter for a single cell 120a. The main difference between the first embodiment and the second embodiment is thus in step S205 wherein, instead of selecting two or more cells as in the first embodiment for joint optimization, two or more antenna parameters are selected in a single cell 120a for joint optimization. As a result, step S206 will involve an antenna search space corresponding to a single cell 120a in the second embodiment, whereas step S206 in the first embodiment involves an antenna search space corresponding to one antenna parameter optimized over two or more cells 120a, 120b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-26. (canceled)

27. A method for improving performance in a wireless communications network, the method comprising a network node:
acquiring an identification of a set of cells for which adjustment is needed;
identifying a reason for the adjustment and improvement possibilities of the set of cells using at least one indicator, wherein the reason and the improvement possibilities define a combination of which parameters and network nodes that could be adjusted; and
determining an improvement action for the set of cells by jointly optimizing the combination of parameters and network nodes based on the reason and the improvement possibilities.

28. The method of claim 27, wherein the combination of parameters and nodes is defined by one antenna parameter and at least two network nodes, or at least two antenna parameters and one network node.

29. The method of claim 27, further comprising performing the improvement action.

30. The method of claim 27, wherein:
the set of cells comprises a single cell;
the identification comprises a list of cells neighboring the single cell.

31. The method of claim 30, wherein the acquiring the identification comprises:
acquiring handover statistics for the single cell with respect to cells in the list of cells;
reducing number of cells in the list of cells based on the handover statistics;
including the reduced number of cells in the set of cells.

32. The method of claim 30, wherein the acquiring the identification comprises:
acquiring an estimate of coverage overlap for the single cell with respect to cells in the list of cells;
reducing number of cells in the list of cells based on the coverage overlap;
including the reduced number of cells in the set of cells.

33. The method of claim 27, wherein:
the acquiring the identification comprises identifying at least one cell for which adjustment is needed;
the at least one cell is part of the set of cells.

34. The method of claim 33, wherein the acquiring the identification comprises selecting the at least one cell from the set of cells based on performance of cells in the set of cells.

35. The method of claim 33, wherein the acquiring the identification comprises selecting the at least one cell from the set of cells in accordance with a probability factor weighted according to the at least one indicator

36. The method of claim 33, wherein the acquiring the identification comprises:
evaluating the improvement possibilities for each cell in the set of cells;
selecting the at least one cell from the set of cells based on the evaluated improvement possibilities.

37. The method of claim 27, wherein the determining the improvement action comprises acquiring performance feedback from the set of cells.

38. The method of claim 27, wherein the indication is based on a performance observation of the set of cells, the performance observation indicating worse performance for the set of cells than for other cells in the wireless communications network.

39. The method of claim 27, wherein the at least one indicator is a key performance indicator.

40. The method of claim 39, wherein the key performance indicator relates to at least one of cell performance, cell load, cell signal strength, cell throughput, and cell interference.

41. The method of claim 27, wherein the at least one indicator is a deployment indicator.

42. The method of claim 41, wherein the deployment indicator relates to at least one of infrastructure information and environmental information of a geographical region corresponding to the set of cells.

43. The method of claim 27, wherein the at least one indicator is a memory indicator.

44. The method of claim 43, wherein the memory indicator relates to any previously performed improvements actions for the set of cells or any previously performed improvements actions for a cell neighboring the set of cells.

45. The method of claim 27, wherein the improvement possibilities relate to at least one of user off-loading, cell interference reduction, and cell coverage improvement.

46. The method of claim 27, wherein the improvement action involves adjustment of at least one of vertical beam direction, horizontal beam direction, and beam width.

47. The method of claim 27, wherein the reason is determined from an observed imbalance between cells in the set of cells; the observed imbalance relating to at least one of load, interference, coverage, and user throughput.

48. A network node for improving performance in a wireless communications network, the network node comprising:
processing circuitry configured to cause the network node to perform a set of operations comprising:
acquiring an identification of a set of cells for which adjustment is needed;
identifying a reason for the adjustment and improvement possibilities of the set of cells using at least one indicator, wherein the reason and the improvement possibilities define a combination of which parameters and network nodes that could be adjusted; and
determining an improvement action for the set of cells by jointly optimizing the combination of parameters and network nodes based on the reason and the improvement possibilities.

49. The network node of claim 48:
further comprising a storage medium storing the set of operations;
wherein the processing circuitry is configured to retrieve the set of operations from the storage medium to cause the network node to perform the set of operations.

50. The network node of claim 48, wherein the set of operations is provided as a set of executable instructions.

51. A computer program product stored in a non-transitory computer readable medium for improving performance in a wireless communications network, the computer program product comprising software instructions which, when run on processing circuitry of a network node, causes the network node to:
acquire an identification of a set of cells for which adjustment is needed;
identify a reason for the adjustment and improvement possibilities of the set of cells using at least one indicator, wherein the reason and the improvement possibilities define a combination of which parameters and network nodes that could be adjusted; and
determine an improvement action for the set of cells by jointly optimizing the combination of parameters and network nodes based on the reason and the improvement possibilities.
